(19) United States
(12) Patent Application Publication
(10) Pub. No.: US 2020/0059751 A1
(43) Pub. Date: Feb. 20, 2020

(54) METHODS AND APPARATUS FOR TRACKING ELECTRONIC DEVICES

(71) Applicant: Kyle William Miko, Coral Springs, FL (US)

(72) Inventor: Kyle William Miko, Coral Springs, FL (US)

(21) Appl. No.: 15/278,930

(22) Filed: Sep. 28, 2016

(51) Int. Cl. H04W 4/02; H01R 33/72; H02J 9/06

(52) U.S. Cl. CPC H04W 4/02; H02J 9/06; H01R 33/72

(57) ABSTRACT

An electronics tracking device is useful for tracking use of electronic devices, such as durable medical equipment (DME), typically used at remote locations, such as a patient's home. The electronics tracking device can be securely attached to an electronic device and a power cord that supplies power to the electronic device can be connected to the tracking device. The tracking device can then be connected, with its own power cord, to power. Power to the electronic device flows through the electronics tracking device. The electronics tracking device includes a wireless communications circuit that permits the device to send a signal to a monitoring location, where the signal includes data regarding whether the electronics tracking device is plugged in and whether the DME is powered on or off. The monitoring location can use exceptions to notify a DME provider when the DME is not used for a certain period of time.

### BACKGROUND OF THE INVENTION

### 1. Field of the Invention

One or more embodiments of the invention relates generally to asset tracking. More particularly, the invention relates to an apparatus that powers an electronic device, such as a medical device, and sends notifications of properties of the use in order to track use of equipment, reallocate non-used medical equipment and find lost equipment.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

There currently is a need in the marketplace for methods for tracking use of medical equipment. Durable medical equipment (DME) providers often provide medical equipment in locations where they cannot monitor the equipment directly, such as in patient's homes.

When the DME is no longer being used, the DME provider typically does not receive any notification that the equipment is not being used and is available for another customer. For example, if the DME customer passes away, the DME may be put aside for weeks or months before someone contacts the DME provider. In some cases, the DME may become discarded or moved to another location when a home or apartment is cleaned. The result is that DME providers must track each customer's use of DME and must further keep additional inventory as compared to if the DME provider was able to retrieve the DME when no longer in use.

In view of the foregoing, there is a need for methods and apparatus for automatically tracking use of electronic devices, such as durable medical equipment.

### SUMMARY OF THE INVENTION

Embodiments of the present invention provide a medical equipment tracking solution, comprising a tracking device operable to receive power via a power connection; medical equipment operable to receive power from the tracking device; a wireless communication module in the tracking device, the wireless communication module sending a signal to a monitoring station, the signal including data signifying at least one of whether the power connection is connected to a power supply and whether the medical equipment is using power via the tracking device.

Embodiments of the present invention further provide a method for tracking medical equipment comprising electrically connecting an equipment power supply, which powers the medical equipment, to a tracking device; electrically connecting a power connection to the tracking device, where power sent to the tracking device via the power connection is operable to provide power to the medical equipment; monitoring data including at least one of whether the power to the tracking device is on and whether the medical equipment is drawing power via the tracking device; and sending, via a wireless communication module, a signal to a monitoring station that includes the data monitored.

Embodiments of the present invention further provide a medical equipment tracking solution, comprising a tracking device operable to receive power via a power connection; medical equipment operable to receive power from the tracking device; a wireless communication module in the tracking device, the wireless communication module sending a signal to a monitoring station, the signal including data signifying at least one of whether the power connection is connected to a power supply and whether the medical equipment is using power via the tracking device; a battery backup module in the tracking device operable to power the wireless communication module when power is not received via the power connection; and a power cord electrically connecting the medical equipment to the tracking device, wherein the power cord terminates into a plug, the plug fitting into a socket on an interior of the tracking device; and the plug is covered by a housing and the housing is affixed to the medical device.

In some embodiments, a battery backup module in the tracking device is operable to power the wireless communication module when power is not received via the power connection.

In some embodiments, a global positioning satellite module in the tracking device is operable to supply position data as a component of the data sent to the monitoring station.

In some embodiments, a memory module in the tracking device stores the data prior to the data being delivered to the monitoring station.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of an electronics tracking device, with its cover removed, according to an exemplary embodiment of the present invention, illustrating a power cord from a device connected thereto;

FIG. 2 is an end view of the electronics tracking device of FIG. 1;

FIG. 3 is a perspective view of the electronics tracking device of FIG. 1 showing both covers removed therefrom;

FIG. 4 is a schematic representation illustrating a top view of an electronics tracking device according to an exemplary embodiment of the present invention;

FIG. 5 is a schematic representation illustrating the electronics tracking device of FIG. 1 connected between a power supply and an electronic device;

FIG. 6 is a schematic representation illustrating an alternate embodiment of an electronics tracking device connected between a power supply and an electronic device; and

FIG. 7 is a schematic representation illustrating an electronic tracking device mounted directly to an electronic device and connected to a power supply.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an electronics tracking device that is useful for tracking use of electronic devices, such as durable medical equipment (DME) typically used at remote locations, such as a patient's home. The electronics tracking device can be securely attached to an electronic device and a power cord that supplies power to the electronic device can be connected to the tracking device. The tracking device can then be connected, with its own power cord, to power. Thus, power to the electronic device flows through the electronics tracking device. The electronics tracking device includes a wireless communications circuit that permits the device to send a signal to a monitoring location, where the signal includes data regarding whether the electronics tracking device is plugged in and whether the DME is powered on or off. The monitoring location can use exceptions to notify a DME provider when the DME is not used for a certain period of time, for example.

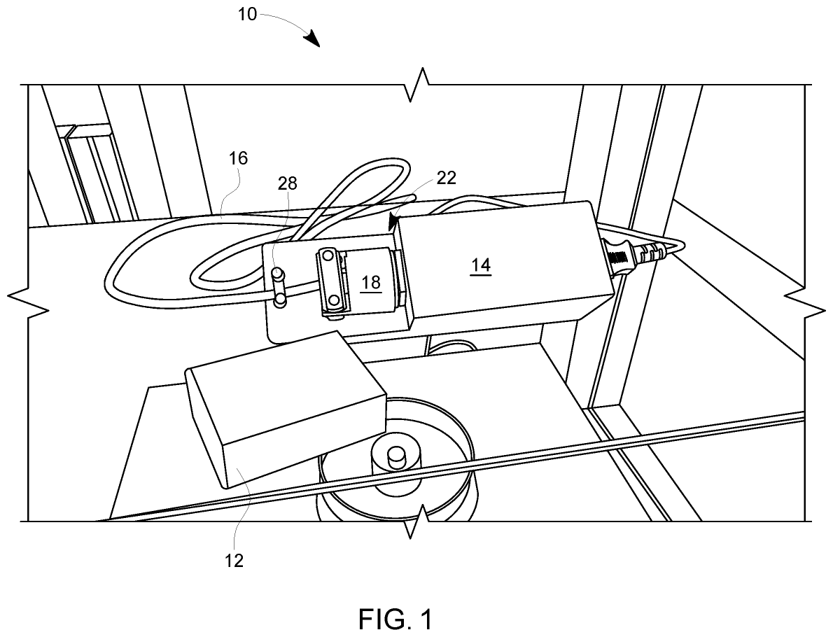

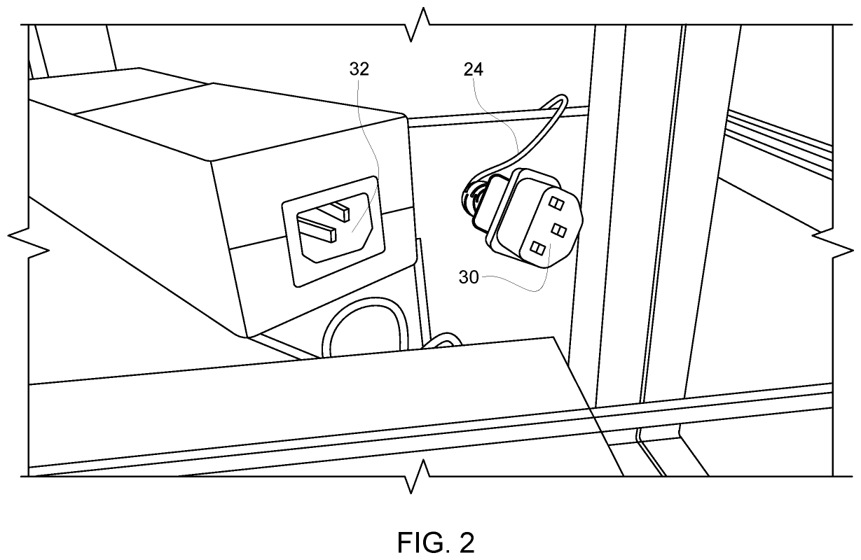

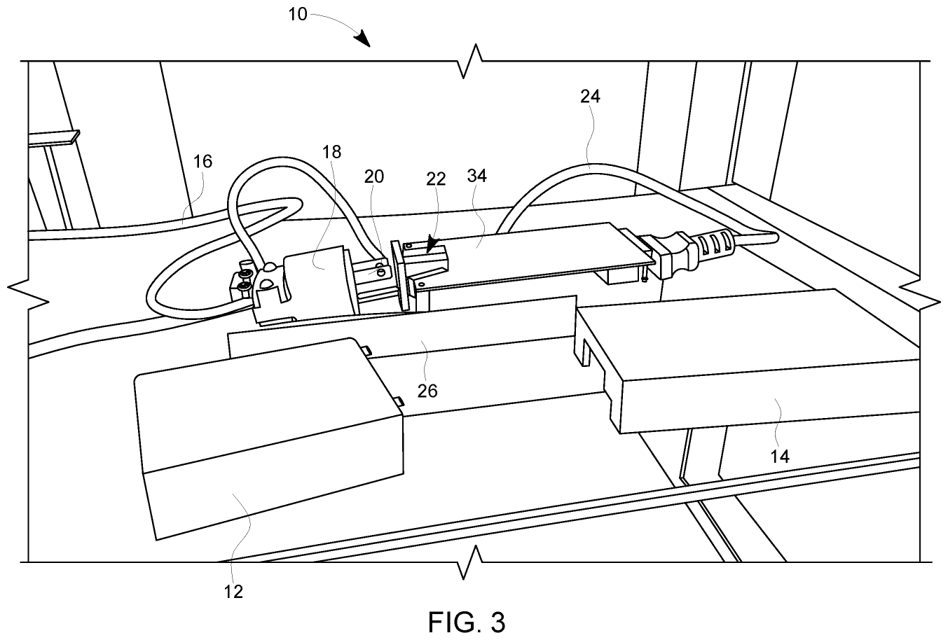

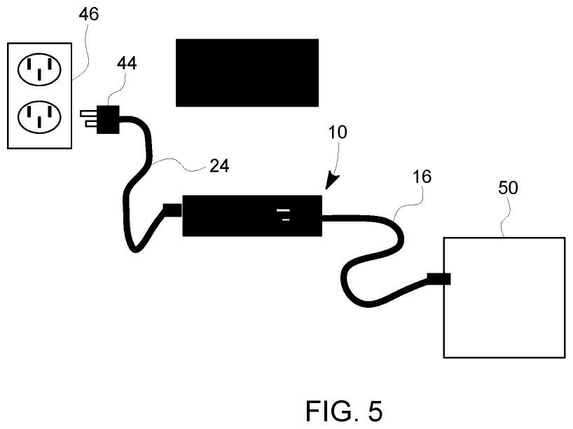

Referring now to FIGS. 1 through 5, an electronics tracking device 10 (also referred to as tracking device 10 or simply device 10) can include a base housing 26 that can be covered with a plug housing 12 and a circuitry cover 14 to form an interior region. In some embodiments, the base housing 26 may be attached to the electronic device 50 via, for example, screw disposed through screw holes 36 formed in the base housing 26.

A plug 18 can connect via a cord 16 to the electronic device 50. The plug 18 can electrically connect into a plug port 22 of the device 10. In some embodiments, the plug 18 can be a standard plug with male prongs 20 that fit into the plug port 22. In some embodiments, the plug 18 can have non-standard prongs 20 so that the electronic device 50 must be powered via the device 10 and no other standard electronic device, without the non-standard prongs 20, may be powered via the device 10.

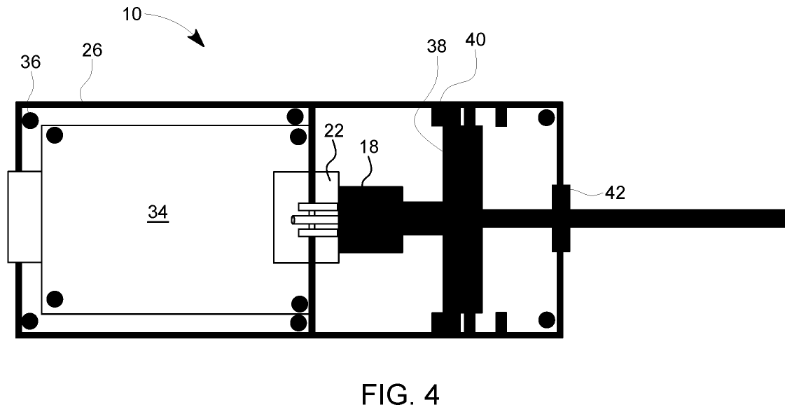

A cord retainer 28 may be disposed within the interior region of the device 10 to secure the cord to the base housing 26. In other embodiments, as shown in FIG. 4, a plug trapper 38 may fit between ridges 40 formed within the interior region of the device 10 to secure the cord 16. In some embodiments, a grommet 42 may be disposed where the cord 16 extends out of the device 10.

The device 10 can receive power via a power cord 24 terminating in a connector 30 that electrically connects to a power port 32 of the device 10. The connector 30 may be, for example, a typical D-connector. Of course, various connections may be used within the scope of the present invention to connect the power cord 24 to the device 10. In some embodiments, the power cord 24 may be hard wired to the device 10, eliminating the connector 30 and the power port 32. The other end of the power cord 24 may include a typical plug 44 that may be electrically connected to a power plug 46.

The device 10 can include a circuit board 34 or other similar circuitry configured to perform the functions of the device 10 as described below. While a single circuit board 34 is shown, the functions may be performed by one or more separate or integrated circuits. The circuit board 34 may include one or more processors 56 operable to perform the tasks as described herein.

The circuit board 34 may include a memory component 52 that can store data to be periodically sent from the device 10. This data may include data regarding whether power is received into the device 10 and whether current is flowing through the device 10 (in other words, whether the electronic device 50 is powered on), for example. This data can be sent via a wireless module 54 to a monitoring location (not shown). In some embodiments, the memory component 52 may be eliminated and the wireless module 54 can simply send a snapshot of the current state of the device 10, including the information described above. The sending of data may be done periodically, such as once every 10-30 minutes, once an hour, 2-4 times a day, once a day, once a week, or the like. In some embodiments, the processor 56 may be programmed to send a wireless signal whenever there is a change in state of the device 10, regardless of the any pre-programmed periodic data sending. For example, the processor 56 may send a signal each hour, signifying that the electronic device 50 is powered on. At 15 minutes past one of the hourly signals, the user may power off the electronic device 50. At that point, the processor 56 may send out a signal that the electronic device 50 is powered off. Unless the electronic device 50 is powered back on, each future periodic data packet will include an indication that the power to the device 50 is off. The wireless module 54 may send data via various communication protocols, such as 3G, 4G, Wi-Fi, SMS, or the like.

In some embodiments, the circuit board 34 can include a global positioning satellite (GPS) chip 58, where the data sent may include location data of the device 10. The monitoring station receiving the data sent from the device may set up alerts if the GPS data is not received or if the location is outside of a particular boundary, for example.

In some embodiments, the circuit board 34 may include a battery back-up module 60 that maintains a battery charge when power is supplied to the device 30 via power cord 24. When power is interrupted, the battery back-up module 60 may provide power so that data monitoring and data sending may still be achieved for a period of time. Moreover, if the device 10 is not receiving power, the data sent from the device 10 may include an indication of such, signifying that the electronic device 50 may no longer be in use.

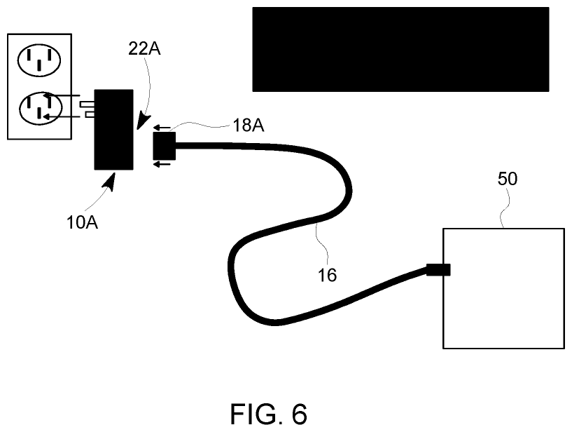

Referring now to FIG. 6, in some embodiments, the power cord 24 may be removed and a device 10A may plug directly into a wall socket. The device 10A may include a port 22A for attaching a plug 18A of the electronic device 50. In this embodiment, because the user has access to the port 22A (there is no cover 12 as in the device 10 described above), the plug 18A may be designed in a non-typical manner so that the plug 18A cannot be directly connected to the wall socket to receive power. In other words, the electronic device 50 must be powered through the device 10A.

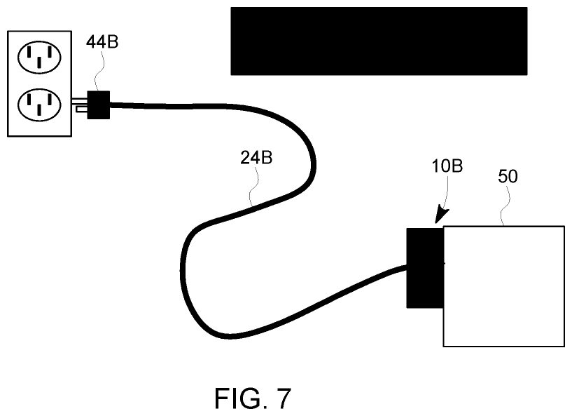

Referring to FIG. 7, in some embodiments, the cord from the electronic device 50 to a tracking device 10B may be eliminated so that the tracking device 10B is hard wired and affixed to the electronic device 50. In this embodiment, a power cord 24B may extend from the device 10B to terminate in a plug 44B that may fit into a standard receptacle.

Regardless of implementation, the device 10, 10A, 10B of the present invention can send a signal to a monitoring station to permit monitoring of the electronic device 50. In some embodiments, the electronic device 50 is medical equipment, such as durable medical equipment (DME), including non-invasive ventilators (NIV), oxygen trans filling equipment, negative pressure would therapy (NPWT), and the like.

The monitoring station (not shown) receives signals from one or more of the tracking devices. In some embodiments, each data stream from each device may be tagged with identifying information so that the monitoring station recognizes each device that is sending information. Typically, a centralized monitoring station will receive signals from a plurality of devices. DME providers, for example, can set up exceptions so that they are notified when certain use feature thresholds are passed. For example, a DME provider can provide an exception that if the device is powered on for more than 2 days in a row, they are notified. In some embodiments, each DME provider may have a portal to program each of their tracking devices, setting data transmit times, data transmit triggers, and notification exceptions. The portal may be software based, web-based, or mobile device app based, for example.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A medical equipment tracking solution, comprising:
a tracking device operable to receive power via a power connection;
a plug port formed in the tracking device, the plug port disposed inside a plug housing;
a cord retainer disposed within the plug housing, the cord retainer configured to secure a power cord of medical equipment to a base of the plug housing, thereby preventing removal of the medial equipment power cord from the tracking device;
a wireless communication module in the tracking device, the wireless communication module sending a signal to a monitoring station, the signal including data signifying at least one of whether the power connection is connected to a power supply and whether the medical equipment is using power via the tracking device.

2. The medical equipment tracking solution of claim 1, further comprising a battery backup module in the tracking device operable to power the wireless communication module when power is not received via the power connection.

3. The medical equipment tracking solution of claim 1, further comprising a global positioning satellite module operable to supply position data as a component of the data sent to the monitoring station.

4. The medical equipment tracking solution of claim 1, further comprising a memory module for storing the data prior to the data being delivered to the monitoring station.

5. (canceled)

6. (canceled)

7. The medical equipment tracking solution of claim 6, wherein the plug is covered by a housing and the housing is affixed to the medical equipment.

8. The medical equipment tracking solution of claim 1, wherein the power cord terminates in a plug, the plug fitting into the tracking device, wherein the plug is configured to prevent connection directly to a standard power receptacle.

9. A method for tracking medical equipment comprising:
electrically connecting a power cord of an equipment power supply, which powers the medical equipment, to a plug port of a tracking device;
securing the power cord to an inside of the tracking device to prevent removal of the medial equipment power cord from the tracking device;
electrically connecting a power connection to the tracking device, where power sent to the tracking device via the power connection is operable to provide power to the medical equipment;
monitoring data including at least one of whether the power to the tracking device is on and whether the medical equipment is drawing power via the tracking device; and
sending, via a wireless communication module, a signal to a monitoring station that includes the data monitored.

10. The method of claim 9, further comprising powering the tracking device with a battery backup module in the tracking device operable when power is not received via the power connection.

11. The method of claim 10, further comprising sending data to the monitoring station wherein the data includes an indication that battery backup power is being used.

12. The method of claim 9, further comprising sending location data obtained by a global positioning satellite module in the tracking device to the monitoring station.

13. The method of claim 9, further comprising storing the data prior to the data being delivered to the monitoring station in a memory module.

14. (canceled)

15. (canceled)

16. The method of claim 9, wherein the power cord terminates in a plug, the plug fitting into the tracking device, wherein the plug is configured to prevent connection directly to a standard power receptacle.

17. A medical equipment tracking solution, comprising:
a tracking device operable to receive power via a power connection;
medical equipment operable to receive power from the tracking device;
a wireless communication module in the tracking device, the wireless communication module sending a signal to a monitoring station, the signal including data signifying at least one of whether the power connection is connected to a power supply and whether the medical equipment is using power via the tracking device;
a battery backup module in the tracking device operable to power the wireless communication module when power is not received via the power connection; and
a power cord electrically connecting the medical equipment to the tracking device, wherein
the power cord terminates into a plug, the plug fitting into a socket on an interior of the tracking device; and
the plug is covered by a housing of the tracking device.
